(19) United States
(12) Patent Application Publication
(10) Pub. No.: US 2007/0299902 A1
(43) Pub. Date: Dec. 27, 2007

(54) Sparse tree adder

(76) Inventors: Mahesh K. Kumashikar, Acton, MA (US); Sanu Mathew, Hillsboro, OR (US); Ram Krishnamurthy, Portland, OR (US); Daniel Jackson, Westford, MA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/475,704

(22) Filed: Jun. 26, 2006

(51) Int. Cl. G06F 7/52

(52) U.S. Cl. 708/650

(57) ABSTRACT

Embodiments disclosed herein provide sparse adder circuits comprising Ling type propagate and generate circuits and sparse carry circuits to efficiently add first and second operands to one another.

### BACKGROUND

Processors have arithmetic logic units (ALUS) to perform calculations involving integers. An ALU generally contains a multiplicity of adder circuits to perform the arithmetic calculations by summing two binary operands together. Adders are generally used by the majority of instructions in controlling the operations of a computer system, microprocessor or the like and are usually performance limiting devices in such systems because they form a core of several critical paths in performing instructions and calculations. For example, typical adder circuits can include over 500 logic gates.

Traditional high performance (e.g., dense tree adder architectures like so-called Kogge-Stone types) use binary carry-merge trees to generate and provide to the summing circuitry a carry signal for each bit. That is, they generate a carry for every two bits summed together for two binary operands. With 64 bit operands, for example, 64 summations and carries are generated—typically in parallel operations. While the time period during which these arithmetic operations are performed is normally extremely fast, unfortunately, such architectures tend to result in large fan-outs requiring large transistors. They also can require wide routing channels for interstage wiring.

Accordingly, in order to reduce the size and complexity of the carry tree architecture, other architectures are sought such as those providing a limited number of carry bits to the sum generation circuitry (e.g. every 16^{th} bit provided to 16-bit conditional sum generating circuits). FIG. 1 shows a Manchester carry chain (MCC) implementation, which is an example of such an architecture. Unfortunately, with these architectures, performance may still be impaired due to excessive bottlenecks through carry merge (CM) gate paths to the sum generators. As indicated in the figure, the carry tree has CM gates with up to four transistors in a stack, which as shown, contribute to a critical path having an associated 32 bit RC delay resulting in slower than desired performance. Such high gate stacks may also tend not to scale well with different semiconductor processes. Accordingly, an improved adder architecture is desired.

### BRIEF DESCRIPTION OF THE DRAWINGS

Embodiments of the invention are illustrated by way of example, and not by way of limitation, in the figures of the accompanying drawings in which like reference numberals refer to similar elements.

FIG. 1 is a diagram of a conventional 64-bit adder circuit with a MCC carry tree architecture.

FIG. 2 is a general diagram of an adder circuit having a sparse carry tree in accordance with some embodiments.

FIG. 3 is a more detailed diagram of the adder circuit of FIG. 2 in accordance with some embodiments.

FIG. 4 is a block diagram of a computer system having a microprocessor with at least one adder circuit in accordance with some embodiments.

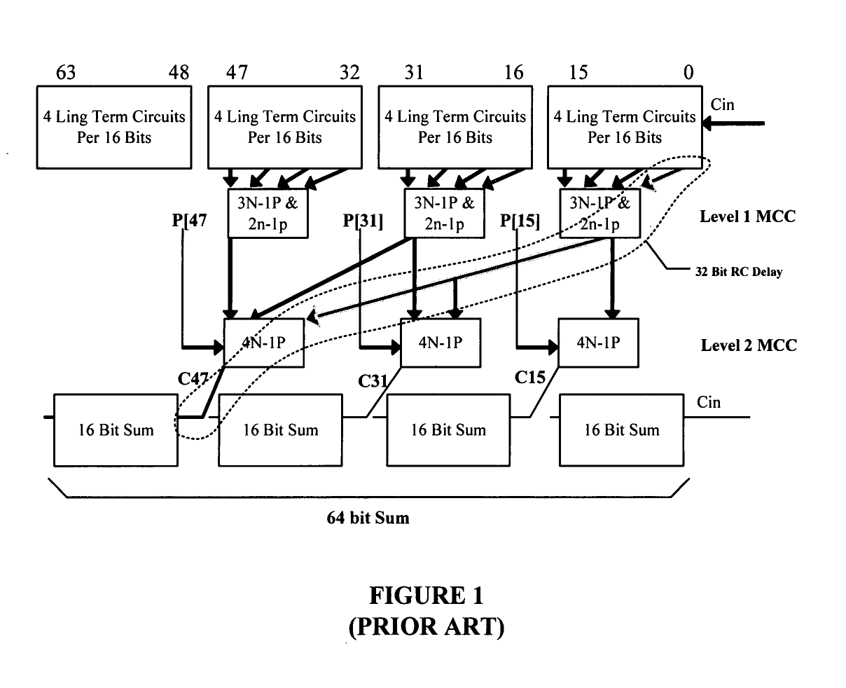

### DETAILED DESCRIPTION

Embodiments disclosed herein generally pertain to implementations of adder circuits using sparse tree architectures having dynamic and static complementary metal oxide semiconductor (CMOS) circuits.

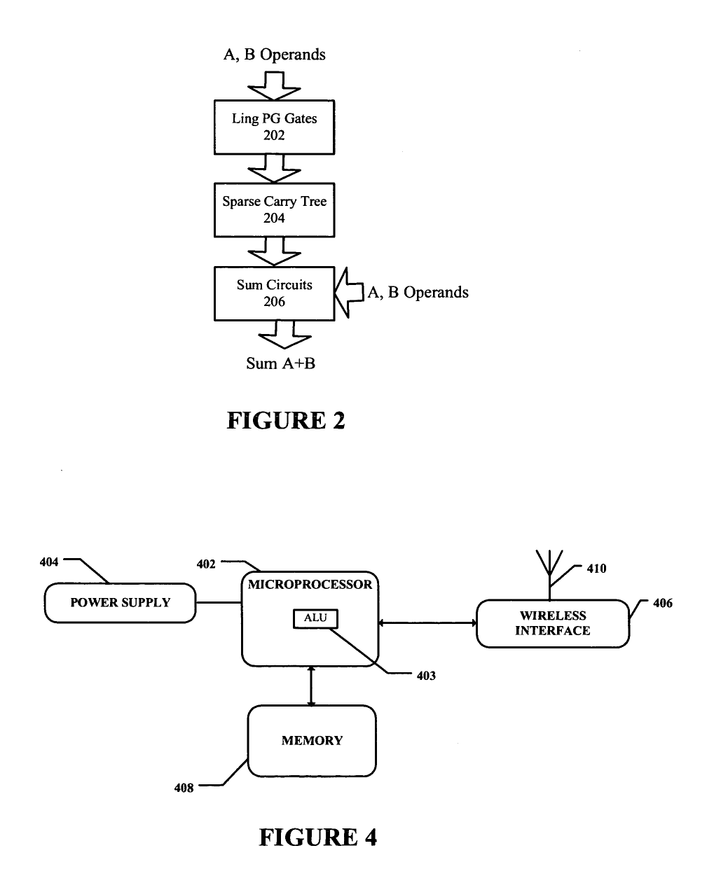

FIG. 2 shows a general diagram of such an adder circuit in accordance with some embodiments. It comprises sparse carry tree circuitry 204 coupled between Ling type group propagate-generate (PG) circuits 202 and sum generator circuits 206. The operands, A and B, (which are to be added together) are provided at inputs of the Ling circuits, as well as to inputs of the sum generator circuits 206. The Ling circuits, as is well known in the art (see, e.g., U.S. Pat. No. 5,719,803 to Naffziger entitled, HIGH SPEED ADDITION USING LING'S EQUATIONS AND DYNAMIC CMOS LOGIC), generate carry propagate and generate (PG) terms from the A and B operands. The PG terms are provided to the sparse carry tree circuitry 204, which generates carry signals for every n^{th} bit and provides them to the sum generator circuits 206 to generate the sum of A and B.

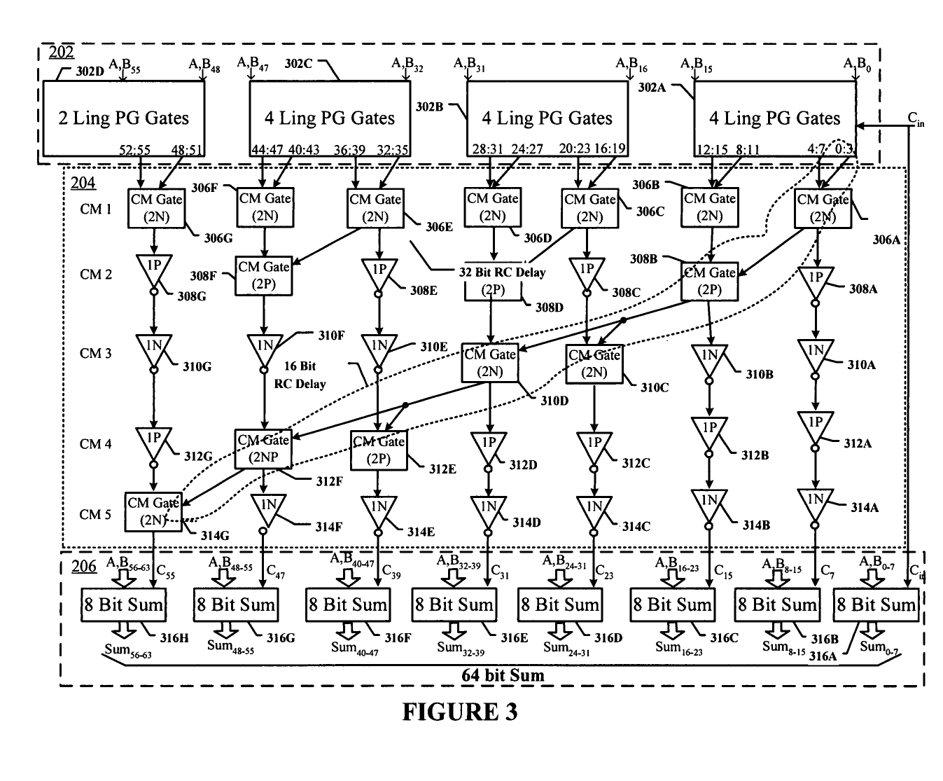

FIG. 3 shows a more detailed implementation of a 64-bit adder circuit in accordance with the adder of FIG. 2. The Ling circuitry 202 is grouped into four quadrants (302A to 302D) to handle 16 bits each. Each quadrant includes four Ling circuits, with each circuit generating PG terms for a 4-bit portion of the applied A and B operands. The Ling circuits output 2-way group-generate (GGᵢ=Gᵢ+PᵢGᵢ₋₁) and group-propagate (GPᵢ=PᵢPᵢ₊₁) signals. In the depicted embodiment, the 4-bit Ling circuits are implemented with domino gates to generate the Ling carry (PG) terms and provide them to the sparse carry tree 204. In some embodiments, they are pre-charged High and have a worst-case 2-NMOS pull-up evaluation path.

The generated Ling PG carry terms are then merged using a sparse carry merge scheme to generate intermediate carry terms. In the depicted embodiment, the sparse carry tree 204 comprises five intermediate carry-merge levels (CM1 to CM5) comprising carry merge gates 306A-G to 314A-G, disposed as indicated the arrows generally depict P and G term connections between the CM gates. The gates are configured to generate carry bits for every 8^{th} bit (C₇, C₁₅ . . . C₅₅) of the 64 bit operands.

The depicted sparse carry tree 204 uses both domino and static gates to achieve good performance and reduced power consumption. Especially in critical paths, CM gates with no more than 2-high transistor stacks are used. As indicated in the figure, with this architecture, the critical path can be made to have a delay length of only 16 RC bits. Moreover, with this architecture, a reduction in wiring complexity can occur, which permits the use of wider/shielded wires on the few performance-critical inter-stage ‘group generate/propagate’ signals.

In some embodiments, CM levels CM1, CM3, and CM5 comprise domino circuits with 2-high dynamic (e.g., footless) NMOS-stacks (represented as 2N), while levels CM2 and CM4 incorporate static gates having 2-high PMOS stacks (represented as 2P). With this configuration, the carry-merge tree has a worst-case evaluation path of 2N-2P-2N-2P-2N in order to generate the carry signals.

(The term “PMOS transistor” refers to a P-type metal oxide semiconductor field effect transistor. Likewise, “NMOS transistor” refers to an N-type metal oxide semiconductor field effect transistor. It should be appreciated that whenever the terms: “transistor”, “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs and oxide thicknesses to mention just a few. Moreover, unless specifically referred to as MOS or the like, the term transistor can include other suitable transistor types, e.g., junction-field-effect transistors, bipolar-junction transistors, and various types of three dimensional transistors, known today or not yet developed.)

The carry bits from the sparse carry tree 204 are provided to sum generation circuits 316, which are also coupled to the input operands (A, B), to generate their sum. In some embodiments, conditional sum generation circuits are used. In this embodiment, each 8-bit sum generator is a conditional sum generator that generates conditional sums for its input carry bit being both 0 and 1 while the sparse tree circuitry calculates the carry values for every eighth bit. With this scheme, the non-criticality of the sum-generator permits the usage, for example, of a ripple carry-merge scheme to generate the conditional carries.

In some embodiments, the 8-bit operand sections and associated conditional carries are XORed together to generate conditional sums in 8-bit sections. Once arriving from the sparse tree circuitry 204, the carry bits (C₇, C₁₅, . . . C₅₅) then select the appropriate 8-bit conditional sums, e.g., using a 2:1 multiplexer to deliver the final 64-bit sum. In this way, logic traditionally implemented in complex main carry-tree, for example, using expensive parallel prefix logic can instead be implemented in the sparse-tree design using an energy-efficient architecture. Such an approach can result in smaller area, reduced energy consumption and lower leakage.

With reference to FIG. 4, one example of a computer system is shown. The depicted system generally comprises a processor 402 that is coupled to a power supply 404, a wireless interface 406, and memory 408. It is coupled to the power supply 404 (e.g., battery and/or AC adapted supply) to receive from it power when in operation. The wireless interface 406 is coupled to an antenna 410 to communicatively link the processor through the wireless interface chip 406 to a wireless network (not shown). Microprocessor 402 also comprises one or more ALUs 403 with one or more adder circuits configured in accordance with adder circuits disclosed herein.

It should be noted that the depicted system could be implemented in different forms. That is, it could be implemented in a single chip module, a circuit board, or a chassis having multiple circuit boards. Similarly, it could constitute one or more complete computers or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

Moreover, it should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
an adder circuit comprising:
one or more Ling circuits to produce propagate and generate terms from first and second input operands;
sparse carry circuitry coupled to the Ling circuits to produce, from the propagate and generate terms, sparse carry bits for the first and second operands; and
sum generation circuitry coupled to the sparse carry circuitry to generate a sum of the first and second operands based on first and second operand inputs and the sparse carry bits.

2. The chip of claim 1, in which the Ling circuits each produce carry propagate and generate signals based on four bits from the first and second operands.

3. The chip of claim 1, in which the first and second operands are 64 bit operands.

4. The chip of claim 3, in which the sparse carry tree circuitry produces carry bits for every eighth bit of the input operands.

5. The chip of claim 1, in which the sparse carry tree comprises carry merge gates with no more than 2-high transistor stacks in a critical path.

6. The chip of claim 5, in which the sparse carry tree comprises at least five intermediate levels of carry merge gates.

7. The chip of claim 6, in which the sparse carry tree comprises static carry merge levels interposed between dynamic carry merge levels.

8. The chip of claim 1, in which the sum generation circuitry comprises ripple carry sum generation circuits.

9. The chip of claim 7, in which the sum generation circuitry comprises conditional sum, ripple carry sum generation circuits to generate at least 2 different sums and to select a correct sum based on a received sparse carry bit.

10. A chip, comprising:
an adder circuit comprising:
one or more Ling circuits to produce propagate and generate terms from first and second input operands;
carry and merge gates coupled together and to the Ling circuits to produce carry bits from the propagate and generate terms,; the carry and merge gates including both static and dynamic gates, the dynamic gates having stack heights not in excess of two transistors; and
sum generation circuitry coupled to the cary and merge gates to generate a sum of the first and second operands based on first and second operand inputs and the produced carry bits.

11. The chip of claim 10, in which the Ling circuits each produce carry propagate and generate signals based on four bits from the first and second operands.

12. The chip of claim 10, in which the first and second operands are 64 bits.

13. The chip of claim 12, in which the carry and merge gates produce carry bits for every eighth bit of the input first and second operands.

14. The chip of claim 13, in which the carry and merge gates are disposed into at least five levels of carry merge gates.

15. The chip of claim 14, in which the carry and merge gates are disposed into levels of static gates interposed between levels of dynamic gates.

16. The chip of claim 10, in which the sum generation circuitry comprises ripple carry sum generation circuits.

17. The chip of claim 16, in which the sum generation circuitry comprises conditional carry, ripple carry sum generation circuits to generate at least 2 different sums and to select a correct sum based on a received carry bit.

18. A system, comprising:
(a) a microprocessor having an ALU with an adder circuit comprising:
(i) one or more Ling circuits to produce propagate and generate terms from first and second input operands,
(ii) sparse carry circuitry coupled to the Ling circuits to produce, from the propagate and generate terms, sparse carry bits for the first and second operands, and
(iii) sum generation circuitry coupled to the sparse carry circuitry to generate a sum of the first and second operands based on first and second operand inputs and the sparse carry bits;
(b) an antenna; and
(c) a wireless interface coupled to the microprocessor and to the antenna to communicatively link the microprocessor to a wireless network.

19. The system of claim 18, further comprising a battery to supply power to the microprocessor.
